(19) United States
(12) Patent Application Publication
(10) Pub. No.: US 2012/0197673 A1
(43) Pub. Date: Aug. 2, 2012

(54) Generating Flight Schedules Using Fare Routings and Rules

(75) Inventors: Carl de Marcken, Seattle, WA (US); Edwin Karat, Somerville, MA (US)

(73) Assignee: Google Inc., a California Corporation

(21) Appl. No.: 13/443,050

(22) Filed: Apr. 10, 2012

Related U.S. Application Data
(62) Division of application No. 10/714,525, filed on Nov. 14, 2003, now abandoned.

(51) Int. Cl. G06Q 10/02

(52) U.S. Cl. 705/6

(57) ABSTRACT

Techniques executed in a computer based travel-planning-system for flight scheduling, includes receiving trip segments, determining constraints on sequences of flights between the endpoints of the trip segments, the constraints derived from properties of fares that can be used with the flights, generating itineraries from flights using the constraints, and pricing the itineraries.

### RELATED APPLICATION

This application is a divisional application from, and hereby claims priority under 35 U.S.C. §120 to, pending U.S. patent application Ser. No. 10/714,525, entitled “Generating Flight Schedules Using Fare Routings and Rules,” by inventors Carl G. DeMarcken and Edwin R. Karat, which was filed on Nov. 14, 2003 (attorney docket no. 16113-4036001).

### BACKGROUND

Travelers and travel agents pose air travel planning queries to computer travel planning systems, such as travel web sites, airline-specific web sites, or interfaces supplied by global distribution systems (GDSs) as used by travel agents. One type of query typically supported by travel planning systems is the so-called low-fare-search (LFS) query. In response to an LFS query these travel-planning systems typically return a list of possible answers, each including flight and price information, although answers may also take other forms such as a pricing graph.

One strategy to perform an LFS query is to first generate a set of possible flight combinations that satisfy the query's time and airport requirements using a “flight scheduler” program and “price” each flight combination to determine a price for the flights. Typically a strategy is devised to select from amongst the priced flight combinations a set of answers to return to the user. This general strategy of first finding flight combinations (“itineraries”) and pricing the flight combinations can be referred to as “itinerary-led search”.

### SUMMARY

According to an aspect of the invention, a method executed in a computer based travel-planning-system, includes receiving trip segments, determining constraints on sequences of flights between the endpoints of the trip segments, the constraints derived from properties of fares that can be used with the flights, generating itineraries from flights using the constraints, and pricing the itineraries.

Other features include the constraints are on flights or itineraries. The fares are fares between endpoints of trip segments. The fares are fares between points connected by single flights to endpoints of trip segments. Generating provides itineraries for a complete trip. Generating provides itineraries separately for each trip segment. The constraints are based on fare routings. The constraints are based on fare carrier. The constraints are based on fare global indicator. The constraints are based on fare maximum permitted mileage. The constraints are restrictions on individual flights used in itineraries. The constraints are constraints on airline/origin/destination triples. The constraints are restrictions on flight origin and destination. The method chooses constraints based on fare price. The method also generates itineraries from flights without considering constraints. Pricing includes pricing the itineraries generated without considering constraints and with considering the constraints and returning the priced itineraries. Pricing includes restricting pricing of itineraries based on the constraints used to produce the itineraries. Restricting pricing of itineraries is based on restrictions on the endpoints of fares considered during pricing. The method includes generating itineraries from flights without considering constraints, pricing the itineraries from flights without considering constraints and with considering the constraints, and returning the priced itineraries.

According to a further aspect of the present invention, a computer program product residing on a computer readable medium for producing itineraries includes instructions for causing a computer to receive trip segments and determine constraints on sequences of flights between the endpoints of the trip segments, the constraints derived from properties of fares that can be used with the flights. The program further includes instructions to generate itineraries from flights using the constraints and price the itineraries.

According to a further aspect of the present invention, an apparatus includes a processor, a memory for executing a computer program product and a computer readable medium storing the computer program product for producing itineraries. The computer program includes instructions for causing the processor to receive trip segments, determine constraints on sequences of flights between the endpoints of the trip segments, the constraints derived from properties of fares that can be used with the flights, generate itineraries from flights using the constraints, and price the itineraries.

According to a further aspect of the present invention, a computer program product residing on a computer readable medium for producing itineraries includes instructions for causing a computer to receive trip segments, determine geographic and airline constraints derived from fare rules to control the manner in which flights are combined prior to the evaluation of fare rules, and generate itineraries by using the constraints.

According to a further aspect of the present invention, a method for producing itineraries includes receiving trip segments, determining geographic and airline constraints derived from fare rules to control the manner in which flights are combined prior to the evaluation of fare rules and generating itineraries by using the constraints.

According to a further aspect of the present invention, a computer program product residing on a computer readable medium for producing itineraries includes instructions for causing a computer to receive trip segments, determine constraints on sequences of flights, between the endpoints of the trip segments the constraints derived from properties of fares that can be used with the flights, generate itineraries constrained by multiple constraints that are derived from a diverse set of fares in order to increase the diversity of generated itineraries, return at least some of the generated itineraries to a user.

According to a further aspect of the present invention, a method for producing itineraries includes receiving trip segments, determining constraints on sequences of flights, between the endpoints of the trip segments the constraints derived from properties of fares that can be used with the flights, generating itineraries constrained by multiple constraints that are derived from a diverse set of fares in order to increase the diversity of generated itineraries and returning at least some of the generated itineraries to a user.

According to a further aspect of the present invention, a method executed in a computer based travel-planning-system, includes receiving trip segments, determining whether fares restricts use of certain sequences of flights between the endpoints of the trip segments, generating itineraries from flights that are not restricted by the fares and pricing the itineraries.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram depicting an example of a travel planning system.

FIG. 2 is flow chart depicting flight scheduling.

FIGS. 3 and 4 are diagrams depicting a graph representation of routings.

FIG. 5 is a flow chart depicting a routing-based scheduling process.

FIGS. 6A-6B are flow charts depicting a process using routings to constrain a flight scheduler.

FIGS. 7A-7B are flow charts depicting a process for using restrictions derived from non-through fares.

FIGS. 8A-8B are flow charts depicting a process for generating diverse itineraries using rules and routings of “through fares.”

FIGS. 9A-9B are flow charts depicting a process to determine constraints.

### DETAILED DESCRIPTION

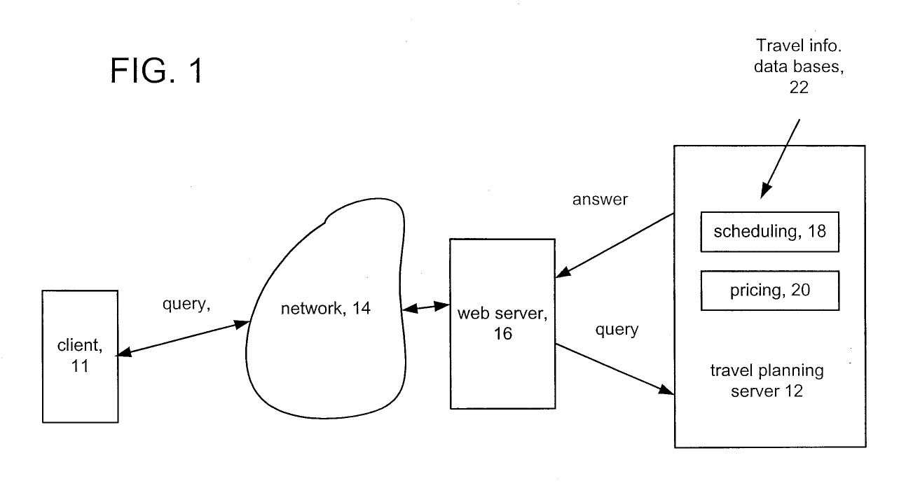

Referring to FIG. 1, a travel planning system (TPS) 10 includes a server type of computer system 12 that searches for airline tickets using so-called large scale or low-fare-search algorithms. The travel planning system 10 finds valid flight sequences between pairs of specified end-points in response to a query received from a client system. In one embodiment, the client 11 communicates with the server 12 via a network such as the Internet 14 through a web server 16. The process 18 of finding flight sequences for a portion of a trip is commonly called “scheduling.” The process 18 uses flight information contained in travel information databases, 22. A particular flight sequence for a portion of a trip is commonly called an “itinerary.” Typically the travel-planning system attempts 10 to find prices for one or more combinations of itineraries from each portion of a trip.

The process 20 of finding prices for a specific combination of itineraries (equivalently, sequence of flights on a ticket) is known as “pricing” a set of flights, or “pricing a ticket” sometimes referred to as a faring process. The process of pricing 20 the flights of a ticket involves retrieving fares from a fare database 22, choosing fares for particular sub-sequences of flights such that all flights are paid for by exactly one fare, and can include grouping fares into priceable-units, and verifying that the fare rules permit the particular choices of fares and priceable-units.

A fare is a price an airline offers for one-way travel between two airports that has associated restrictions on its usage called “rules”. If a fare's rules permit, a fare may be used to pay for more than one flight, and tickets may be priced using more than one fare. Although it can sometimes be beneficial to pay for a ticket using many fares, airlines frequently charge proportionally less for fares for trips that cover longer distances rather than fares for trips that cover shorter distances. Thus, when traveling from Boston (BOS) to Los Angeles (LAX) connecting in Dallas (DFW) and Denver (DEN), it is likely that the cheapest pricing will involve a single Boston to Los Angeles fare that pays for all three flights rather than two or three fares. That is, it would be unusual (although not impossible) for the sum of a BOS-DFW fare, a DFW-DEN fare and a DEN-LAX fare to “undercut” a BOS-LAX “through fare.” A “through fare” is used to refer to a fare between the endpoints of a trip segment. In contrast, using multiple smaller fares to price a trip is often called “point-to-point” pricing.

In international travel airlines publish fares in markets that often require many flights to get between. For example, many airlines publish Boston to Easter Island (IPC) fares even though four or more flights may be necessary to make such a trip. Using a single BOS-IPC fare is usually substantially cheaper than pricing a trip using smaller fares that cover sub-portions of the trip. Assuming that in this example, no one airline offers service for all parts of such a trip, it is necessary to use multiple airlines' flights. The fare rules for an airline's BOS-IPC fares will typically restrict the airlines that can be used for different parts of the trip (for example, British Airways might publish a fare that requires using their own flights from Boston to London and from London to Buenos Aires, but then permit various specific South American airlines to fly the remainder of the trip using any one of several routes originating in Buenos Aires). Given the large number of airline and flight combinations that could be used to get from BOS to IPC, the chance that a flight scheduler based on convenience alone will produce an itinerary that meets the particular restrictions of a BOS-IPC fare is small.

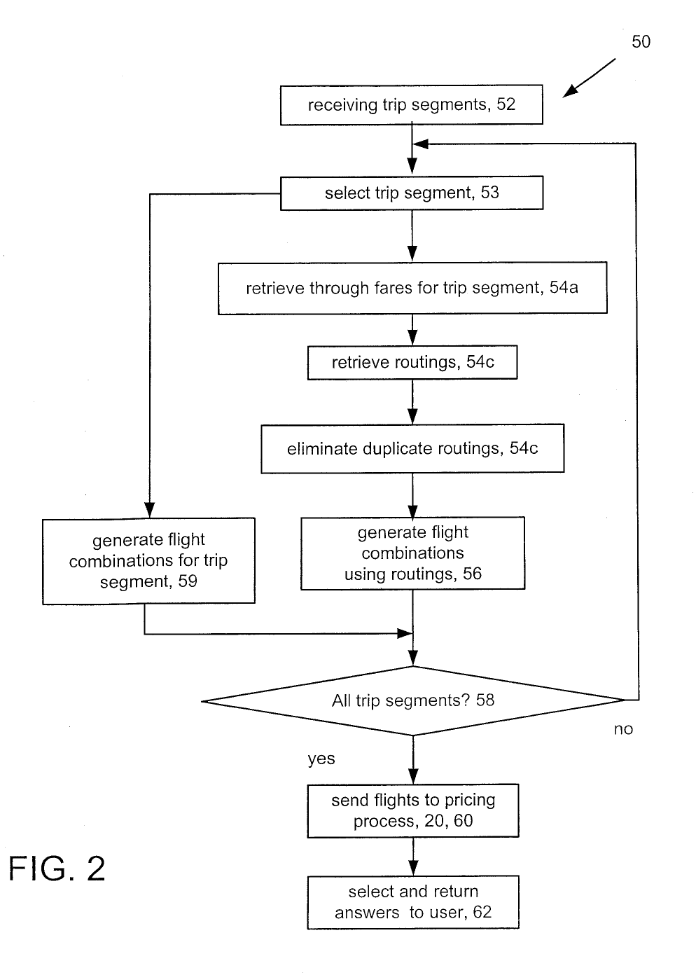

Referring to FIG. 2, a flight scheduling process is shown. The flight scheduling process uses information in the rules of “through fares” to assist the flight scheduler to generate flight combinations that satisfy the “through fares” rules, so that cheaper prices are achieved than on itineraries that can only be priced point-to-point. One part of a fare rule is a “routing.” Many fares are published with a routing. A routing is a description of the routes and airlines that may be used in conjunction with a fare. In the airline industry most fares and their rules (including routings) are published electronically by airlines in a common format defined by the Airline Tariff Publishing (ATP) Company.

While a fare may restrict the flights, fares permit other constraints, such as through other parts of its rules (in particular for ATP fares, through rule “categories” 4, 8, 9 and 999 and through a “maximum permitted mileage”). The routing is typically the primary source of a constraint, and a flight combination that satisfies the fare's routing, does not contain excessively long layovers, and has proper seat availability is quite likely to satisfy a fare's rules.

A general process 50 for a flight scheduler 18 in the TPS 10 includes receiving 52 trip segments, and iterating over each trip segment by selecting 53 a trip segment, by retrieving 54a “through fares” on all airlines. The process looks up 54b the routings of each of the through fares that has routings and eliminates duplicate routings 54c. The process iterates 58 over all trip segments and eliminates 56 any duplicate routings.

For each trip segment, for each non-duplicate routing, the process 50 generates 56 some flight combinations that are constrained by the routing, but which otherwise satisfy user defined constraints on query time, origin and destination and so forth. The process 50 also generates 59 flight combinations that are unconstrained by fare routings based on the original query information for each trip segment. The process 50 sends 60 the determined flight combinations (both constrained and unconstrained) to a faring process 20, in order to price 62 the flight combinations. The process 50 selects and returns 62 answers to the user.

Although “through fare” routings provide valuable information that can be used to inform a flight scheduler so that it produces cheaper itineraries, there are many situations where it is insufficient for a TPS to use this strategy, such as when fares do not have published routings; when the cheapest answer involves point-to-point pricing; when it is not possible to satisfy “through fare” routings or their other rules; when it is desirable to retrieve many convenient itineraries in addition to the cheapest answers and so forth. For these reasons it is typically beneficial for a flight scheduler to generate both the most convenient itineraries and also those that satisfy fare routings.

The ATP electronic format for fare routings is complex. It may be desirable to translate routings into a simpler format more suitable for use as a flight scheduler constraint. The ATP routings can be expressed as a directed graph of airlines and cities, with the interpretation that a routing permits a flight combination if the ordered sequence of airports and airlines is a sub-path of some path in the graph.

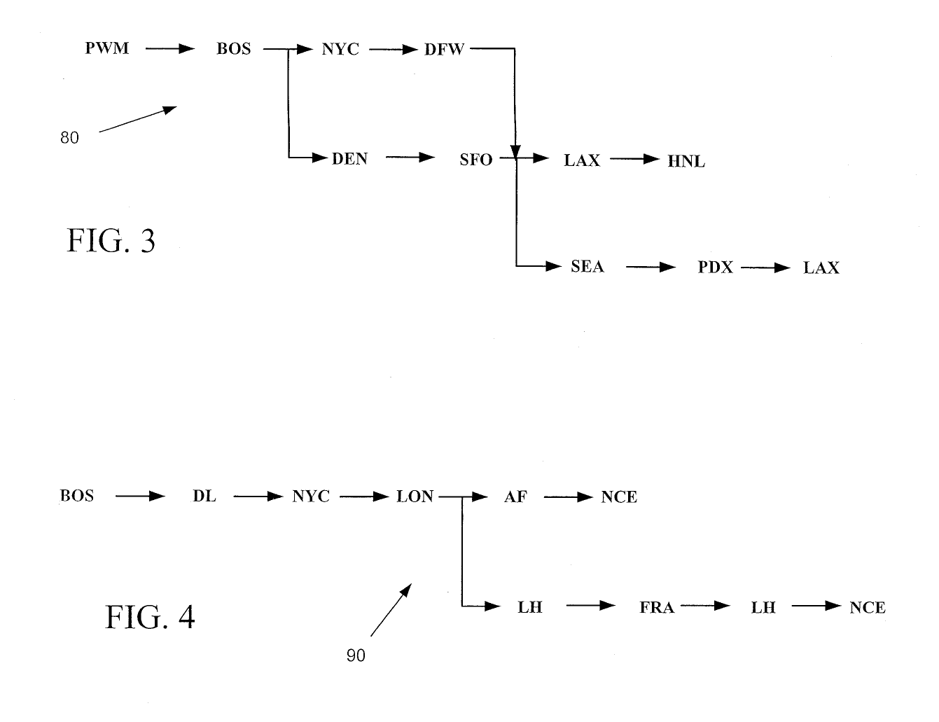

Referring to FIG. 3, an example 80 of a graphic representation of an ATP fare routing for a hypothetical American Airlines (AA) BOS-LAX fare is shown. In graph 80 there are many cities besides BOS and LAX as possible intermediate points. Airlines frequently use a single routing for many different markets, thus this routing could be shared between BOS-LAX fares, PWM-LAX fares, PWM-HNL fares, and various other markets.

This routing has four paths between BOS and LAX. These paths are:

BOS-NYC-DFW-LAX

BOS-DEN-SFO-LAX

BOS-NYC-DFW-SEA-PDX-LAX

BOS-DEN-SFO-SEA-PDX-LAX

The routing permits any sub-path of these paths as a valid route for the fare, where a sub-path is a sequence that includes the same endpoints but optionally omits intermediate stops. If no airlines are included in the routing graph there is an assumption that only the airline publishing the fare may be flown. Therefore, assuming that American Airlines (AA) is the airline, any of the following are valid flight routes for this fare:

BOS-AA-LAX

BOS-AA-NYC-AA-LAX

BOS-AA-DFW-AA-LAX

BOS-AA-NYC-AA-DFW-AA-LAX

BOS-AA-DEN-AA-LAX

BOS-AA-DEN-AA-SEA-AA-LAX

BOS-AA-SFO-AA-PDX-AA-LAX

(and various others)

However, the following paths are not valid flight routes because they have an intermediate city that is not in the routing or not in the path between the end points, or use non-permitted airlines.

BOS-AA-MIA-AA-LAX

BOS-AA-HNL-AA-LAX

BOS-AA-NYC-AA-SFO-AA-LAX

BOS-DL-LAX

BOS-AA-NYC-NW-LAX

Referring to FIG. 4, international routings typically include airlines in the graph. For example, British Airways might publish a routing for travel between Boston and Nice represented as graph 90. The routing represented by graph 90 would permit any of the following as valid flight routes:

BOS-BA-NCE

BOS-DL-NYC-BA-NCE

BOS-DL-NYC-BA-LON-BA-NCE

BOS-DL-NYC-BA-LON-AF-NCE

BOS-DL-NYC-BA-LON-LH-NCE

BOS-DL-NYC-BA-LON-LH-FRA-LH-NCE

Techniques to translate a routing into a form usable by a flight scheduler program would depend on the form of the flight scheduler. Many flight scheduler programs, such as those provided by global distribution systems (GDSs) for use by travel agents, can take a sequence of layover points and airlines as input. With these types of flight schedulers it would be possible to first enumerate from the routing all valid flight routes (using a standard graph path enumeration algorithm such as depth-first-search) and pass each flight route in turn to a flight scheduler to generate itineraries constrained to the route. However for a large routing there can be very large number of paths, so that it is would not be practical to enumerate the flight routes explicitly nor practical to schedule from the flight routes even if all flight routes were enumerated.

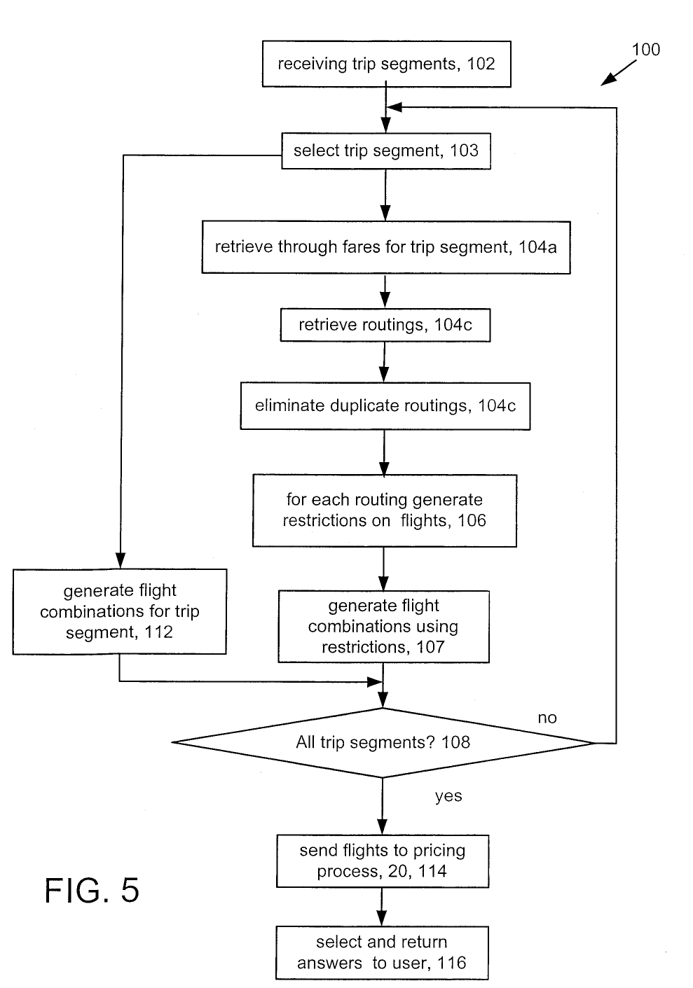

Flight scheduling algorithms can be modified to accept restrictions on flights used to build itineraries. For example, one type of scheduler incrementally extends partial itineraries by adding flights (partial itinerary scheduler). In such a scheduler, the scheduler can impose a test on individual flights (on one or more of the origin, destination, airline, time or flight number) to determine if they may be used to extend a partial itinerary. Therefore, the scheduler uses hints that re-express a fare routing in terms of restrictions on individual flights, as shown in FIG. 5.

Referring to FIG. 5, a routing-based process 100 for a flight scheduler 18 in the TPS 10 includes receiving 102 trip segments, and iterating over each trip segment 103 by looking up 104a “through fares” on all airlines. For each of the through fares that has routings, the process looks up 104b the routings and eliminates duplicate routings 104c. The process iterates 104 over all trip segments 108.

For each trip segment, for each non-duplicate routing, the process 100 uses the routing to generate 106 restrictions on individual flight and runs 107 the flight scheduler incorporating flight restrictions to generate flight combinations that satisfy query time and origin and destination constraints and so forth. The process 100 also generates 112 flight combinations that are unconstrained by fare routings, based on the original query information for the trip segment. The process 100 sends 114 the determined flight combinations (both constrained and unconstrained) to the faring process 20, in order to price 116 the flight combinations. The process 100 selects and returns 118 answers to the user.

One way to re-express fare routings as restrictions on individual flights is to translate the routing into a set of permitted flight origin/destination/airline triples, so that only flights that match these triples are considered by the scheduler. An advantage to such a scheme is that while there may be many valid routes permitted by a routing (exponential in the number of routing nodes), there can only be a quadratic number of flight origin/destination/airline triples (quadratic in the number of routing nodes).

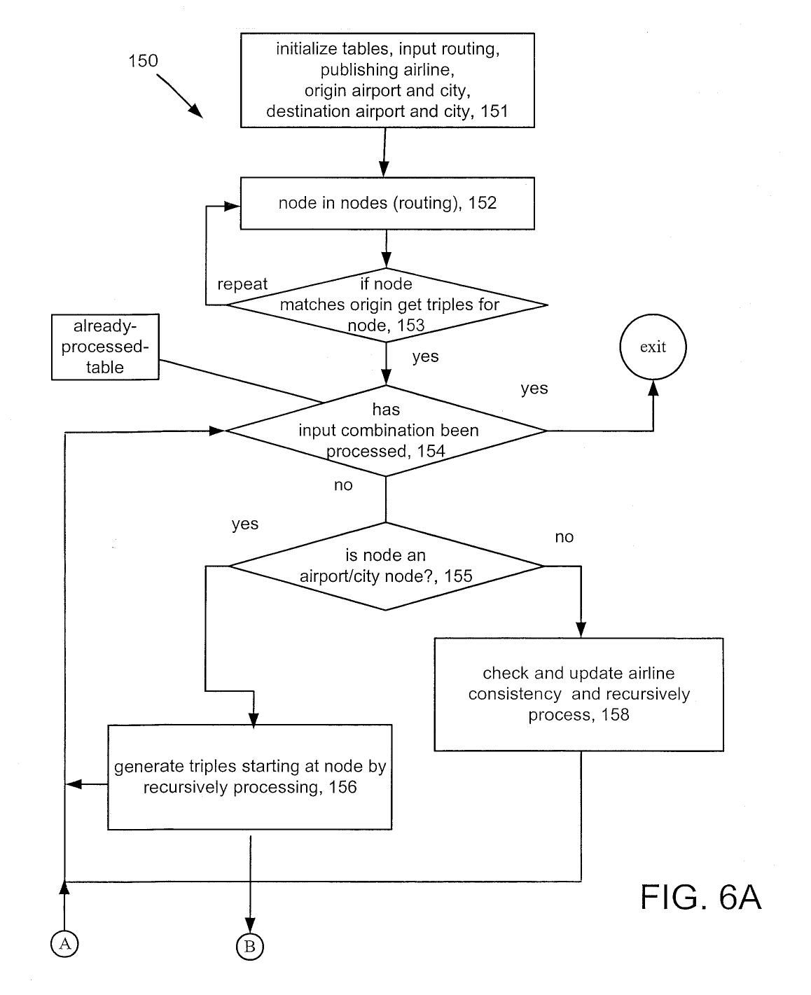

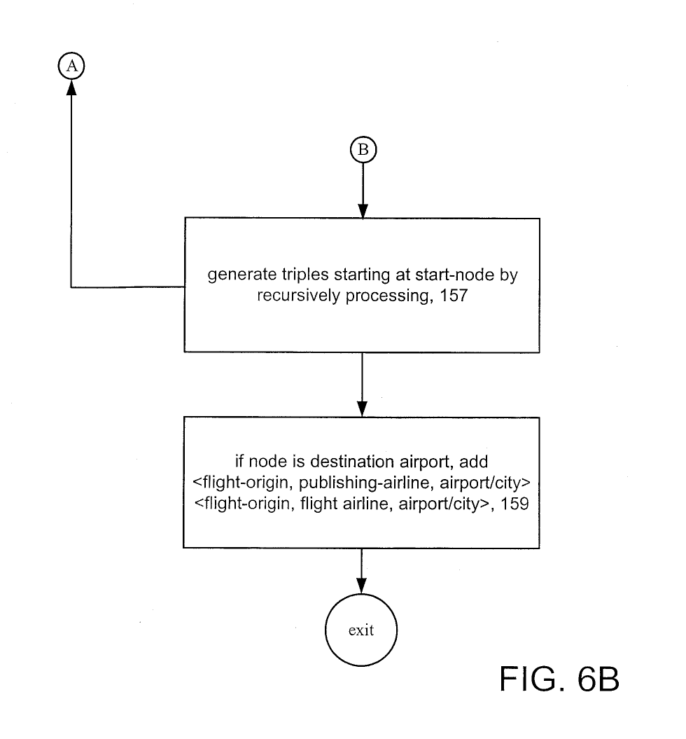

Referring to FIGS. 6A-6B, a process 150 that generates a set of origin/destination/airline triples for all the flights that a specific routing permits (on any valid route) between a specified origin and destination airport is shown. The 150 process receives 151 routings, publishing-airline, origin-airport and city, destination-airport and city and initializes 151 data structures triples={ } and already-processed-table={ }. The process 150 for each node 152 in nodes(routing) determines 153 if the node matches the origin of the trip segment. If there is a match the process 150 gets triples for the node using a recursive subroutine that takes as input a triple start node, a current node, triple origin, and triple airline. The subroutine determines 154 if the input combination has been processed previously. If the input combination has been processed, the subroutine 154 exits. Otherwise, the process 150 checks 155 if the node is an airport/city node. If it is an airport/city node, the process 150 generates triples starting at the node 156 by for each node in next nodes(node) invoking the subroutine recursively with new triple start node and new current node and empty triple airline. The process 150 also generates triples starting at the previous start-node 157 by for each node in next nodes(node) invoking the subroutine recursively with updated triple airline and current node. The process determines 159 if node is the destination airport of the trip segment and if so adds <flight-origin, publishing-airline, airport/city> and <flight-origin, flight airline, airport/city> to the set of triples.

On the other hand, if the node is not an airport/city node the process 150 lets 158 airline=node airline (node) and if airline is consistent with flight-airline, the process updates flight airline by for each node “n” in next-nodes (node) invoking the subroutine recursively with updated triple airline and current node. The paths from elements 156-159 back to element 154 are provided to illustrate the general recursiveness of the subroutine that exits after a pass but that can be executed again recursively.

Thus, for the British Airways Boston-Nice example routing given above, it will return

<BOS, NYC, DL>

<BOS, NYC, BA>

<BOS, LON, BA>

<BOS, NCE, BA>

<BOS, FRA, BA>

<NYC, LON, BA>

<NYC, NCE, BA>

<NYC, FRA, BA>

<LON, NCE, AF>

<LON, NCE, BA>

<LON, FRA, LH>

<LON, FRA, BA>

<LON, NCE, LH>

<FRA, NCE, LH>

<FRA, NCE, BA>

For this routing, if the flight scheduler limits the flights it considers to those that match this set of origin/destination/airline triples, it is guaranteed that any itinerary it generates will be allowed by the fares' routing.

This is not true for all routings. It is possible for some routings that the set of triples generated will permit some routes that the routing does not allow, but in practice this circumstance would be rare. Nevertheless, any valid itinerary will include only flights that match the triples generated by this process.

Pseudo Code to generate triples is shown in TABLE 1.

TABLE 1
input routing
input publishing-airline
input origin-airport
input destination-airport
input origin-city
input destination-city
let all-triples = { }
let already-processed-table = { }
for node in nodes(routing) {

if (node-type(node) = ‘airport/city’) {

airport/city = node-airport/city(node)
if (airport/city == origin-airport or airport/city == origin-city) {

for (n in next-nodes(node)) {

generate-triples(n, node, airport/city, nil)

}

}

}

}
return all-triples
function generate-triples(node, start-node, flight-origin, flight-airline) {

//
// Return true if on path to destination airport, false otherwise
//
let key = <node, start-node, flight-origin, flight-airline>
let reaches-destination = lookup(already-processed-table, key)
if (reaches-destination <> ‘empty’) {

return reaches-destination

}
reaches-destination = false
if (node-type(node) = ‘airport/city’) {

let airport/city = node-airport/city(node)
// generate triples starting at this node and ending at
subsequent node
for (n in next-nodes(node)) {

reaches-destination = reaches-destination or
generate-triples(n, node, airport/city, nil)

}
// generate triples starting at start-node and ending at
subsequent node
if (flight-airline == nil) { flight-airline = publishing-airline }
for (n in next-nodes(node)) {

reaches-destination = reaches-destination or

generate-triples(n, start-node, flight-origin,
flight-airline)

}
// generating triples ending at this node
let at-destination = (airport/city == destination-airport or
airport/city == destination-city)
if (at-destination) {

reaches-destination = true
all-triples = union(all-triples, { <flight-origin,
publishing-airline, airport/city> })
all-triples = union(all-triples, { <flight-origin,
flight-airline, airport/city> })

}

}
else if (node-type(node) = ‘airline’) {

let airline = node-airline(node)
if (flight-airline == nil or flight-airline == airline) {

for (n in next-nodes(node)) {

reaches-destination = reaches-destination or
generate-triples(n, start-node, flight-origin, airline)

}

}

}
store(already-processed-table, key, reaches-destination)
return reaches-destination

}

There are other possible ways to modify flight scheduling programs to use fare routings. For example, a flight scheduler such as the type that uses partial itineraries as described above may be augmented to store on partial itineraries a list of possible routing nodes that represent those points in the routing reachable by the partial path. The flights are only added to a partial path if the flights are to an airport that is a descendant of one of the routing nodes listed on the partial path.

Routings are not the only flight constraints imposed by fares. While fare rules can be quite complex and can impose restrictions on flights through a variety of mechanisms, certain ones are particularly useful for informing a flight scheduling program.

Many fares impose a restriction on the total mileage of all flights paid for by the fare. Such fare restrictions are often called the “maximum permitted mileage”, or MPM. Typically this is in the range of 20% greater than the minimum achievable flight mileage between the endpoints of the fare. Thus, when running a flight scheduling program that uses hints generated by a fare's routing, information regarding the fares MPM is passed to the flight scheduling program. The flight scheduling program is augmented by a process that tests whether a proposed itinerary will exceed the MPM. In this manner the flight scheduler does not produce itineraries that exceed the MPM.

This can be achieved in a flight scheduling program such as the partial itinerary based one mentioned above by maintaining on each partial path the total mileage of all flights in the partial path, and declining to add a new flight to the partial path if the sum of the new flight's mileage and the partial path mileage exceed the MPM.

Some fares do not contain a routing, relying instead on other fare rules and the structure of the flight network to limit the number and geography of the flights that may be paid for by the fare. Although such fares may in theory permit travel on other airlines than the airline that publishes the fare, in general such fares only permit travel on the publishing airline. Conversely, it is very likely that an “online” flight sequence of flights on the publishing carrier will satisfy the fare's rules. Thus, in absence of a fare routing it is a useful heuristic to restrict flights to those on the airline that publishes the fare. Most commercially viable flight scheduling programs are built to accept such single-airline restrictions, as travelers frequently request solutions on airlines of their choice.

Many fares contain a two-character identifier called the “global indicator” that restricts the general geographic route of a fare. For example, a Los Angeles to London (LAX-LON) fare may be given the global indicator AT, meaning “Atlantic”, restricting routes to travel over the Atlantic Ocean. Approximately 30 different global indicators exist, including PA (“Pacific”), PO (“Polar”), and WH (“within the Western Hemisphere”). Such global indicators act in conjunction with fare routings, MPMs, and other constraints on fare flights. For example, the AT global indicator requires a flight across the Atlantic ocean and prohibits flights across the Pacific ocean, thus ensuring for a LAX-LON fare that one does not fly LAX-SYD-PAR-LON. Each global indicator can be associated with a set of prohibited locations and prohibited location pairs. For example, AT can be associated with the sets:

LOCATION

Africa
Asia
Australia

| LOCATION 1 | LOCATION 2 |
|---|---|
| North America | South America |

Thus, for a LAX-LON fare with the AT global indicator, flights would be prohibited if either endpoint was in Africa, Asia or Australia, and if the flight was between North America and South America (in either direction). Since these geographic restrictions restrict individual flights, they can be incorporated into a flight scheduling program in the same way that origin/destination/airline triples can.

Most fares have many rules besides those that restrict flights. For example, it is typical for fares to restrict the dates and time of travel. Therefore not all fares are applicable for all travel queries. In the processes 50 and 100, it may be desirable to avoid considering those fares that clearly cannot be used for the query, so as to limit computation and avoid generating superfluous itineraries. While it can be difficult to use a fare's rules to predict whether those rules can be satisfied, in practice there are certain fare properties that can be checked easily, that in many cases absolutely determine that a fare's rules cannot be satisfied and the fare may be safely ignored. Among those are fares' effective and discontinue dates, seasonality rules (ATP “category 3”), and day-of-week rules (ATP “category 2”).

The computational effort involved in pricing itineraries is such that for most pricing systems only a moderate number of itineraries can be practically priced in response to LFS queries. If the number that can be practically priced is fixed, then any itineraries produced by heuristic techniques based on fare routings necessarily take the place of others that could otherwise be priced, possibly lowering the quality of search if the heuristics are poor. However, the use of through fares increases the likelihood that itineraries priced using through fares will be cheap. That is, if through fare routings or other rule restrictions are used to generate an itinerary from A to E through B, C and D, and that itinerary would not otherwise have been generated by the flight scheduler, then the TPS pricing module can be informed that when pricing this itinerary only A to E fares need be considered, rather than fare combinations such as A-C+C-E and A-B+B-D+D-E. With such a restriction there is no guarantee that the cheapest pricing of this itinerary will be found, but for long itineraries in most pricing systems, which expend the vast majority of their resources considering fare combinations rather than single fares, a restriction to through fares may dramatically reduce the time and effort necessary for pricing each itinerary. This reduction may make it possible for an itinerary-led TPS to practically price a larger number of heuristically generated itineraries (priced constrained to through-fares) in addition to those that would have otherwise been generated by the flight scheduling module. It is a standard feature of pricing systems to accept limitations on the endpoints of fares, so such a through-fare limitation is easily imposed.

Airlines do not publish through fares between all airport pairs. This is especially true for small airport pairs that may not be service by “major” airlines. For example, while Minneapolis (MSP) is served by many major airlines who publish fares from MSP to most other major cities, some airports, currently for example, LYU in Ely, Minn. is served by only one airline, with flights to only one other city, Minneapolis. LYU has fares published to few if any international destinations. For a trip from Ely (LYU) to Manchester, England (MAN) it may be necessary to switch between airlines and to use multiple fares. Quite likely the cheapest faring will be that of a LYU-MSP fare combined with the cheapest achievable MSP-MAN fare. Sometime for small markets for foreign travel airlines produce so called “constructed fares”, which are a combination of a published fare between two gateways, e.g., major markets and an “add-on”, e.g., an arbitrary fare that by itself is not useable as a fare. For even smaller markets there does not exist add-ons and thus, constructed fares.

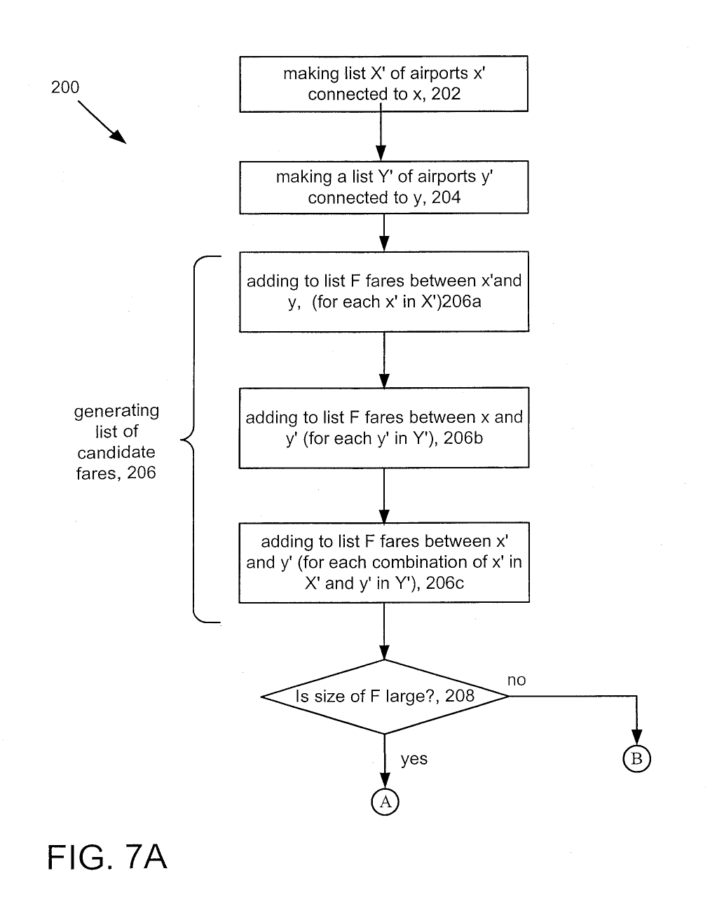

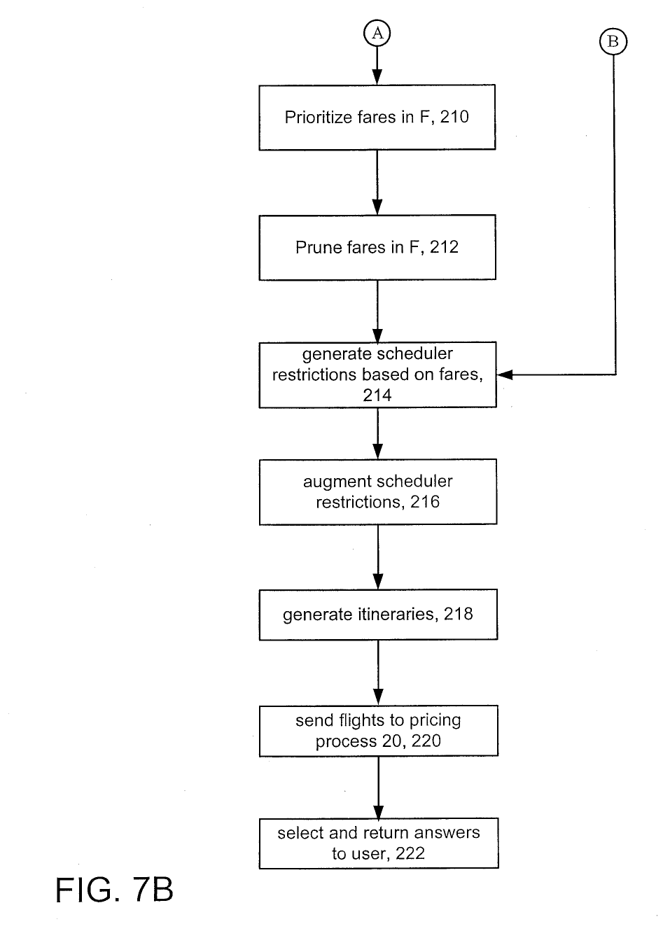

Referring to FIGS. 7A-7B, a process 200 for using restrictions derived from non-through fares for travel planning between two airports x and y which do not have published fares between them, or only a small number of published fares between them, is shown. The process 200 includes making 202 a list of airports X′ connected by a single flight to x, making 204 a list of airports Y′ connected by a single flight to y and generating 206 a list of candidate fares F. The process for generating 206 a list of candidate fares includes for each x′ in X′, adding 206a to F any fares published between x′ and y; and for each y′ in Y′, adding 206b to F any fares published between x and y; and for each combination of x in X′ and y′ in Y′, and adding 206c to F any fares published between x′ and y′. The process 200 checks 208 if F is large (e.g., the number of fares in F). If F is not large (the value of what constitutes a large number of fares being chosen by a user based on various considerations such as computation cost and speed, etc.) the process 200 generates scheduler restrictions 214 based on the fares and continues as shown in FIG. 7b. However if the value of F is large, the process prioritizes 210 the fares in F using a sort function that may take into account such fare minimum travel distance (e.g., for x′ to y fare, dist (x,x′)+dist(x′,y)) minimum cost (e.g., for x′ to y fare f, cost of f plus cost of minimum fare published from x to x′) and prunes 212 fares to include only top ranked fares.

For each fare in F with unique routing and endpoints, as per FIG. 2, the process generates 214 scheduler restrictions from fare, augments 216 scheduler restrictions to allow for any necessary additional flights between endpoints of fare and trip endpoints, such as flight from x to x′ or from y′ to y, and generates 218 itineraries using flight scheduler constrained by restrictions.

As with the through fares, in absence of a fare routing the process 200 can use other scheduler restrictions for fares in F derived from the fare's MPM, the publishing carrier, the global indicator, and so on.

If using this technique an itinerary has been heuristically generated from a fare x′ to y′, the techniques mentioned above should not be used to limit the pricing of that itinerary to through fares (x-y fares). However, pricing efficiency can be enhanced by limiting the endpoints of fares to x, y, x′ and y′. Thus, for an A-B-C-D-E itinerary generated using scheduler constraints derived from a B-D fare, pricing can be limited to fares with endpoints A, B, D and E, but not C.

For some trip endpoints there may be more “through fares” with unique routings (or other rule aspects that affect the generation of flight scheduler constraints) than can be practically used to constrain the flight scheduler. For instance, various limits can be imposed, such as computational effort expended by the scheduler to process a query, or the computational effort expended by the TPS to price itineraries. It may be necessary to prioritize and limit the number of constraints generated and/or limit the number of itineraries generated by the flight scheduler for each constraint.

Since one airline may publish multiple fares with different routings that for the purpose of a particular pair of trip endpoints act alike, and since different airlines typically have very different fare prices and rules, it is typically advantageous to try to ensure as much airline diversity as possible in the selection of fares from which to generate scheduler constraints. For example, given a practical limit of 40 total scheduler constraints for a query from A to B, if 15 airlines publish fares from A to B, and some of these carriers have as many as 20 different routings (or other features used to generate scheduler constraints), it would typically be more advantageous to choose 2 constraints from each of the airlines, regardless of fare price, than to choose 20 constraints from each of 2 airlines, even if those 2 airlines have universally cheaper fares than the other airlines. This is generally true since it is not correct to assume that a cheap fare's rules will pass allowing use of the fare.

If an LFS query includes multiple origin or destination airports, with different fares published to each city, then it is likewise advantageous to ensure origin and destination diversity by apportioning constraints fairly between the different origin/destination pairs.

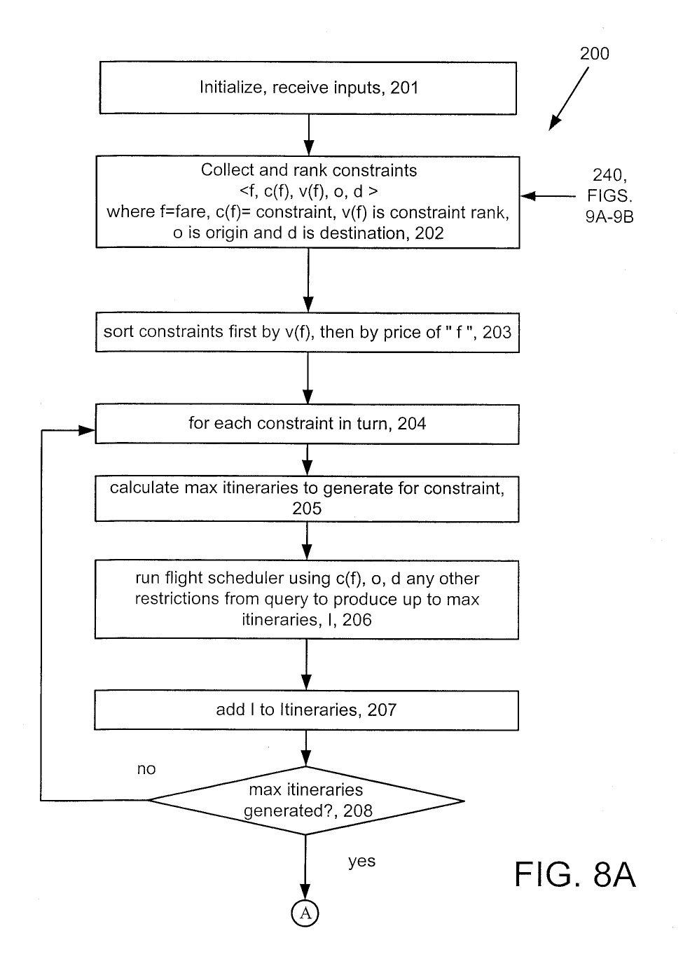

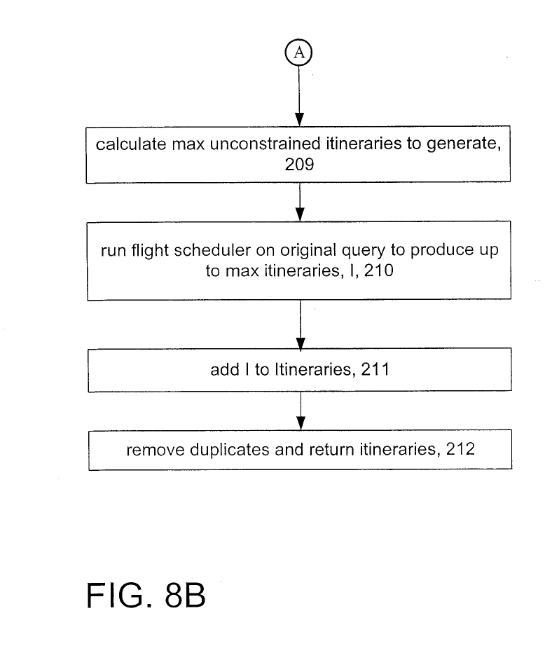

Referring to FIGS. 8A and 8B, a process 200 for generating diverse itineraries using a flight scheduler that uses the rules and routings of “through fares” to augment the itineraries produced using the flight scheduler is shown. The process 200 attempts to ensure airline/origin/destination diversity of the fares used to generate flight scheduler constraints by ranking constraints in such away that the first (cheapest) constraint from each airline/origin/destination is taken before the second from any. It also allows for control over the total number of itineraries produced heuristically, and the number produced for any particular constraint (fare routing). Many variations are possible, such as ones that prioritize constraints in other ways or that allow for other controls on the allocation of itineraries (such as allowing for per-airline limits) and resource consumption (such as allowing for limits on the total time spent generating itineraries using fare rule constraints).

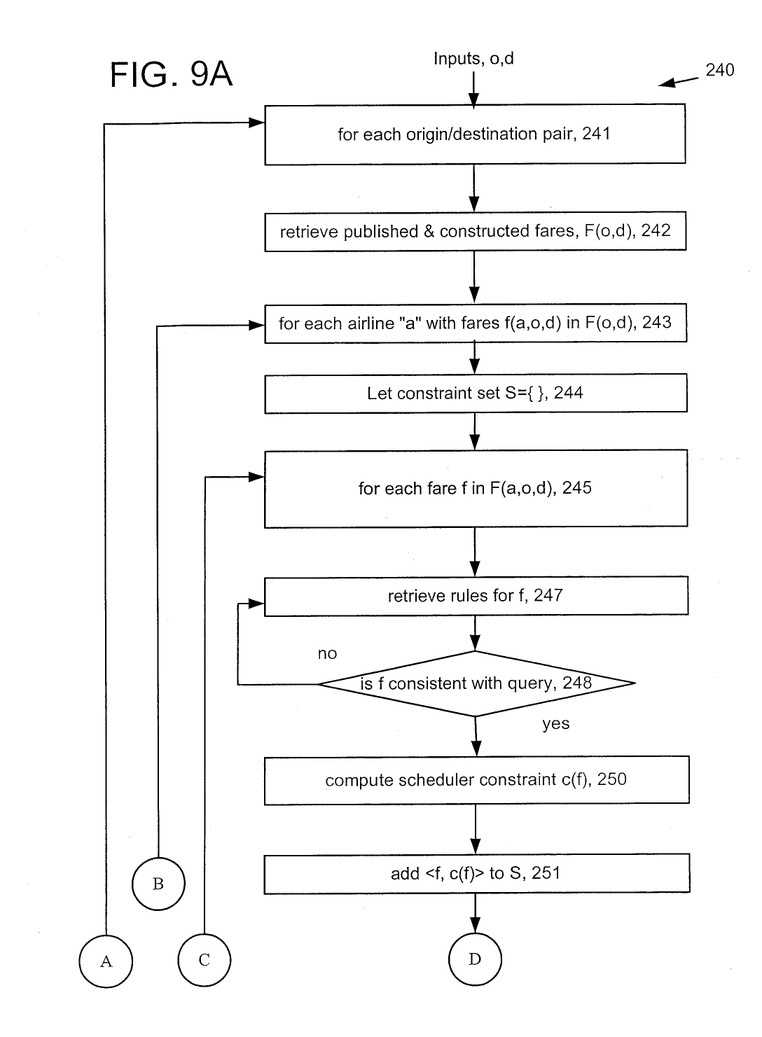

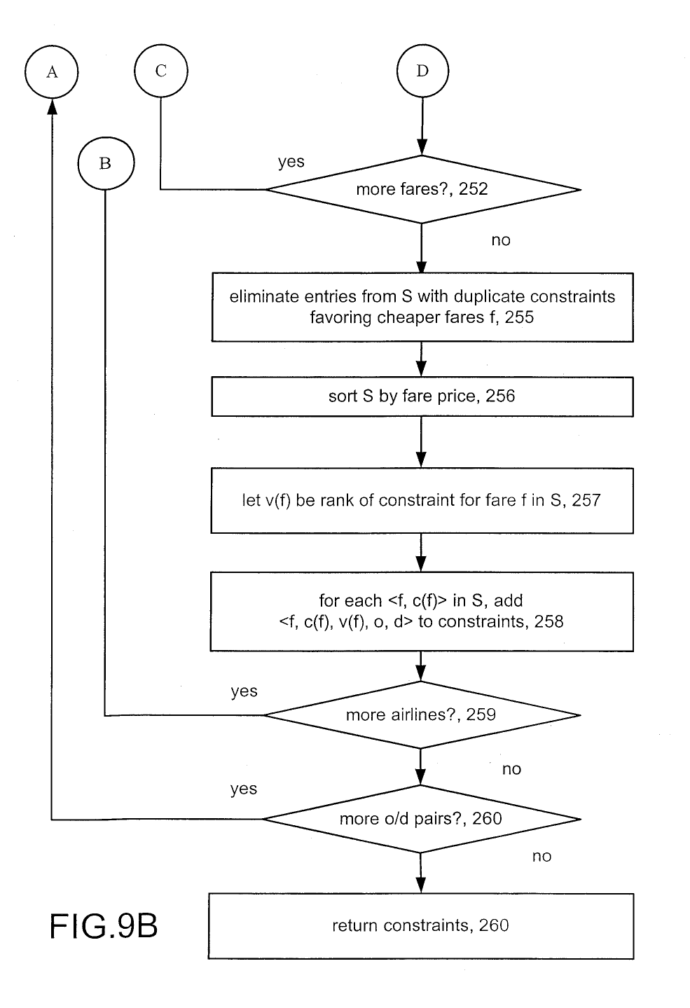

Process 200 initializes 201a set of constraints to be empty. The process 200 collects 202 and ranks constraints <f, c(f), v(f), o, d>, where f=fare, c(f)=constraint, v(f) is a constraint rank, o is the origin and d is destination. A process to produce constraints is shown in FIGS. 9A-9B. The process 200 sorts 203 constraints, first by v(f) and then by price of fares f. The process 200 for each constraint 204, calculates 205 a maximum number of itineraries to generate for the constraint, runs 206 the flight scheduler using c(f), o, d and any other restrictions from query to produce itineraries 1 up to the maximum number of itineraries. The process 200 adds 207 the itineraries to a list and determines 208 if the maximum number has been generated. If not it continues, if it has, the process 200 calculates 209 a maximum number of unconstrained itineraries to generate, runs 210 the flight scheduler on original query to produce up to the maximum number of itineraries, I and adds 211 the itineraries to a list. The process 200 removes 212 duplicates and returns itineraries.

Referring to FIGS. 9A and 9B, a process 240 to determine constraints is shown. Process 240 for 241 each origin/destination pair, retrieves 242 published & constructed fares, F(o,d). Process 240 for 243 each airline “a” with fares F(a,o,d) in F(o,d) lets 244 a constraint set S={ } and for 245 each fare fin F(a,o,d), retrieves 246 rules for f and determines 248 if the fare f is consistent with the original query. If it is consistent the process 240 computes 250 scheduler constraint c(f), add 251 <f, c(f)> to S and determines 252 if there are more fares. After all fares have been determined, the process 240 eliminates 255 entries from S with duplicate constraints favoring cheaper fares f, sorts 256 S by fare price and ranks 257 the fares by letting v(f) be rank (position) of constraint for fare fin S and for each <f, c(f)> in S, adds 258 <f, c(f), v(f), o, d> to constraints. The process checks 259 if there are more airlines, more o/d pairs 260 and if not return 262 constraints. Pseudo code for this process, along with the process of FIGS. 8A and 8B is shown in TABLE 2.

Pseudo Code for generating diverse itineraries using a flight scheduler that uses the rules and routings of “through fares” is shown in TABLE 2.

TABLE 2
input max-itins-per-constraint

input max-constraint-itins (may be infinity)
input max-ordinary-itins (may be infinity)
input max-itins (may be infinity)
input departure-date, origins, destinations
let Constraints = { }
for each O/D pair retrieve published & constructed fares F(o,d) from o to d

for each airline a with fares in F(o,d)

let F(a,o,d) be set of fares on a in F(o,d)

let S = { }
for each fare f in F(a,o,d)

retrieve rules for f
if fare rules (e.g., category 2 & 3, effective & discontinue dates)

are consistent with departure-date and possibly other
features such as passenger type

compute scheduler constraint c(f) based on fare rules

and routing, for example using the algorithm of
figure 3 to produce a constraint based on f's routing
where c(f) is a set of permissible origin/airline/destination
triples

add <f, c(f)> to S

sort S by fare price, cheapest first
eliminate entries in S with duplicate scheduler constraints,

favoring cheaper fares (i.e, if two fares f1 and f2 have
c(f1) = c(f2), and <f1, c(f1)> appears first in S, remove
<f2, c(f2)> from S

assign to fare f a precedence value v(f) equal to its rank in S

(i.e., the cheapest fare has v = 1, the second v = 2, etc)

for each <f, c(f)> in S, add <f, c(f), v(f), o, d> to constraints

let Itins = { }
let number-itins-generated = 0
for each <f, c(f), v(f), o, d> in Constraints, sorted first by v(f), then by

price of f

run scheduler using constraints c(f), origin o, destination d,

```
  departure-date and other restrictions from the original query,
  with a maximum number of itineraries to generate of
  min(max-itins-per-constraint,
```

min(max-constraint-itins, max-itins) − number-itins-generated),

producing set of itineraries I

Itins = Itins + I
number-itins-generated += size(I)
if number-itins-generated >= min(max-constraint-itins, max-itins)

break;

if number-itins-generated < max-itins

run flight scheduler using original query options, adding non-duplicate

itineraries to Itins, limiting number produced to max-ordinary-itins,
and total size of Itins to max-itins

return Itins

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for producing itineraries for flights comprising:
receiving, by a computing system including one or more computers, trip segments;
determining, by operation of a computer, constraints on sequences of flights which can be used between endpoints of the trip segments, the constraints derived from through fares between the endpoints of the trip segments;
subsequent to determining constraints on sequence of flights between the endpoints of the trip segments, generating, by operation of a computer, itineraries of valid flight routes using the constraints to select which flights to include in the generated itineraries;
generating, by operation of a computer, additional itineraries from flights without considering the constraints derived from the through fares between the endpoints of the trip segments;
pricing, by operation of a computer, the itineraries and the additional itineraries; and
providing information for a plurality of the itineraries and a plurality of the additional itineraries.

2. The method of claim 1 wherein the constraints are on specific flights that may make up an itinerary.

3. The method of claim 1 wherein the constraints are on itineraries.

4. The method of claim 1 wherein generating itineraries of valid flight routes using the constraints provides itineraries for a complete trip.

5. The method of claim 1 wherein generating itineraries of valid flight routes using the constraints provides itineraries separately for each trip segment.

6. The method of claim 1 wherein the constraints are based on fare routings.

7. The method of claim 1 wherein the constraints are based on fare carrier.

8. The method of claim 1 wherein the constraints are based on fare global indicator.

9. The method of claim 1 wherein the constraints are based on fare maximum permitted mileage.

10. The method of claim 1 wherein the constraints are constraints on airline and origin and destination triples.

11. A computer program product residing on a computer readable medium comprising instructions for causing one or more computers to:
receive trip segments;
determine constraints on sequences of flights which can be used between endpoints of the trip segments, the constraints derived from through fares between the endpoints of the trip segments;
subsequent to determining constraints on sequence of flights between the endpoints of the trip segments, generate itineraries of valid flight routes using the constraints to select which flights to include in the generated itineraries;
generate additional itineraries from flights without considering the constraints derived from the through fares between the endpoints of the trip segments;
price the itineraries and the additional itineraries; and
provide information for a plurality of the itineraries and a plurality of the additional itineraries.

12. The computer program product of claim 11 wherein the constraints are on specific flights that may make up an itinerary.

13. The computer program product of claim 11 wherein the constraints are on itineraries.

14. The computer program product of claim 11 wherein generating itineraries of valid flight routes using the constraints provides itineraries for a complete trip.

15. The computer program product of claim 11 wherein generating itineraries of valid flight routes using the constraints provides itineraries separately for each trip segment.

16. The computer program product of claim 11 wherein the constraints are based on fare routings.

17. The computer program product of claim 11 wherein the constraints are based on fare carrier.

18. The computer program product of claim 11 wherein the constraints are based on fare global indicator.

19. The computer program product of claim 11 wherein the constraints are based on fare maximum permitted mileage.

20. The computer program product of claim 11 wherein the constraints are constraints on airline and origin and destination triples.

21. A system for producing itineraries for flights comprising:
one or more computers;
one or more memory modules; and
instructions stored on the one or more memory modules and operable when executed by the one or more computers to cause operations comprising:
receiving trip segments;
determining constraints on sequences of flights which can be used between endpoints of the trip segments, the constraints derived from through fares between the endpoints of the trip segments;
subsequent to determining constraints on sequence of flights between the endpoints of the trip segments, generating itineraries of valid flight routes using the constraints to select which flights to include in the generated itineraries;
generating additional itineraries from flights without considering the constraints derived from the through fares between the endpoints of the trip segments;
pricing the itineraries and the additional itineraries; and
providing information for a plurality of the itineraries and a plurality of the additional itineraries.

22. The system of claim 21 wherein the constraints are on specific flights that may make up an itinerary.

23. The system of claim 21 wherein the constraints are on itineraries.

24. The system of claim 21 wherein generating itineraries of valid flight routes using the constraints provides itineraries for a complete trip.

25. The system of claim 21 wherein generating itineraries of valid flight routes using the constraints provides itineraries separately for each trip segment.

26. The system of claim 21 wherein the constraints are based on fare routings.

27. The system of claim 21 wherein the constraints are based on fare carrier.

28. The system of claim 21 wherein the constraints are based on fare global indicator.

29. The system of claim 21 wherein the constraints are based on fare maximum permitted mileage.

30. The system of claim 21 wherein the constraints are constraints on airline and origin and destination triples.
